(19) United States
(12) Patent Application Publication
(10) Pub. No.: US 2026/0004174 A1
(43) Pub. Date: Jan. 1, 2026

(54) METHOD AND SYSTEM FOR NOISE CANCELLATION BASED ON QUBIT FEEDBACK

(71) Applicants: IonQ, Inc., College Park, MD (US); Duke University, Durham, NC (US)

(72) Inventors: Ismail Volkan INLEK, Kensington, MD (US); Christopher MONROE, Durham, NC (US)

(21) Appl. No.: 18/668,784

(22) Filed: May 20, 2024

Related U.S. Application Data
(60) Provisional application No. 63/503,838, filed on May 23, 2023.

(51) Int. Cl. G06N 10/40

(52) U.S. Cl. CPC G06N 10/40

(57) ABSTRACT

Aspects of the present disclosure relate generally to systems and methods for use in the implementation and/or operation of quantum information processing (QIP) systems, and more particularly, to the use of qubit feedback for noise cancellation in quantum elements and/or quantum computations in QIP systems.

### CLAIM OF PRIORITY

The present application claims priority to U.S. Provisional Application No. 63/503,838, filed on May 23, 2023, and hereby incorporated herein by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Other implementations include those based on superconducting qubits or photonic qubits, for example. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to aspects of present disclosure, a computer-implemented method is provided. The method includes detecting sensor data comprising a noise spectrum by at least one sensor. The method further includes calculating frequency components of noise in a quantum information processing (QIP) system based on the sensor data. The method also includes determining amplitude components and phase components of the noise, based on qubit data comprising a current state of a qubit due to the noise and an expected state of the qubit without the noise. The method additionally includes configuring a noise cancelling (NC) waveform generator to generate NC waveforms in accordance with NC frequency components, NC amplitude components, and NC phase components that are based on the frequency components and the amplitude and phase components of the noise. The method further includes applying, by the NC waveform generator, the NC waveforms to a hardware based NC element to cancel out the noise.

According to other aspects of the present disclosure, a computing system is provided. The computing system includes a hardware based noise cancelling (NC) element. The computing system further includes a waveform generator operatively coupled to the hardware based NC element and configured to apply NC waveforms to the hardware based NC element to cancel out noise in the computing system. The computing system also includes at least one processor operatively coupled to the waveform generator. The computing system additionally includes a controller configured to detect sensor data comprising a noise spectrum by at least one sensor. The controller is further configured to calculate frequency components of noise in a quantum information processing (QIP) system based on the sensor data. The controller is also configured to determine amplitude components and phase components of the noise, based on qubit data comprising a current state of a qubit due to the noise and an expected state of the qubit without the noise. The controller is additionally configured to configure a noise cancelling (NC) waveform generator to generate NC waveforms in accordance with NC frequency components, NC amplitude components, and NC phase components that are based on the frequency components and the amplitude and phase components of the noise.

According to further aspects of the present disclosure, a quantum information processing (QIP) system is provided. The QIP system includes a hardware based noise cancelling (NC) element. The QIP system further includes a waveform generator operatively coupled to the hardware based NC element and configured to apply NC waveforms to the hardware based NC element to cancel out noise in the QIP system. The QIP system also includes at least one processor operatively coupled to the waveform generator. The QIP system additionally includes a controller configured to detect sensor data comprising a noise spectrum by at least one sensor. The controller is further configured to calculate frequency components of noise in a quantum information processing (QIP) system based on the sensor data. The controller is also configured to determine amplitude components and phase components of the noise, based on qubit data comprising a current state of a qubit due to the noise and an expected state of the qubit without the noise. The controller is additionally configured to configure a noise cancelling (NC) waveform generator to generate NC waveforms in accordance with NC frequency components, NC amplitude components, and NC phase components that are based on the frequency components and the amplitude and phase components of the noise.

According to additional aspects of the present invention, a computer-implemented method is provided. The method includes determining at least one of: (i) frequency components of noise in quantum gates of a quantum information processing (QIP) system, based on sensor data comprising a noise spectrum captured by sensors; and (ii) amplitude components and (iii) phase components of the noise, based on qubit data comprising a current state of a qubit due to the noise and an expected state of the qubit without the noise. The method further includes configuring quantum gate drivers to generate noise cancelling (NC) signals in accordance with the at least one of NC frequency components, NC amplitude components, and NC phase components that are based on the frequency components and the amplitude and phase components of the noise. The method also includes applying, by the quantum gate drivers, the NC signals to the quantum gates to cancel out the noise.

This disclosure describes various aspects of methods and systems that use noise cancellation via qubit feedback to reduce errors in QIP systems.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of various components of a noise cancellation system in conjunction with cooperative elements of a QIP system in accordance with aspects of this disclosure.

FIG. 5 illustrates another example of various components of a noise cancellation system in conjunction with cooperative elements of a QIP system in accordance with aspects of this disclosure.

FIG. 6 illustrates yet another example of various components of a noise cancellation system in conjunction with cooperative elements of a QIP system in accordance with aspects of this disclosure.

FIGS. 7-9 illustrate an example of a noise cancellation method 700 for a QIP system in accordance with aspects of this disclosure.

FIG. 10 illustrates an example plot of amplitude versus time for a 1 Hz periodic noise signal in accordance with aspects of this disclosure.

FIG. 11 illustrates an example plot of clickstream amplitude versus phase for the 1 HZ periodic noise signal of FIG. 10 in accordance with aspects of this disclosure.

FIG. 12 illustrates an example plot of clickstream amplitude versus compensation signal amplitude in accordance with aspects of this disclosure.

FIG. 13 illustrates an example plot of contrast versus delay corresponding to Ramsey experiments in accordance with aspects of this disclosure.

FIG. 14 illustrates another example plot of contrast versus delay corresponding to Ramsey experiments in accordance with aspects of this disclosure.

### DETAILED DESCRIPTION

In quantum computers (QCs), external electromagnetic and/or mechanical noise may result in unaccounted for qubit evolution and result in errors. The present disclosure recognizes and addresses the issue of external electromagnetic and/or mechanical noise cancellation in QCs and proposes noise cancellation systems and methods in QCs.

In an aspect, a method for noise cancellation is proposed of using electric or magnetic field sensors in conjunction with qubits to directly probe the noise and apply an opposing field to cancel out the noise. In an aspect, the sensors are only used for triggering the waveform generator to synchronize the noise and cancellation fields. In an aspect, a true noise representation between the qubits and the sensors is not required. Rather, the sensors provide the information on frequency and timing components of the noise cancellation field, while the qubits may be used to tune in the amplitude and phase components.

In an aspect, a method for noise cancellation is proposed of using mechanical actuators on mirrors to account for mechanical noise in a QC.

In an aspect, a method for noise cancellation is proposed of adjusting the amplitude, phase or frequency of the fields driving quantum gates to account for changes in the qubit evolution due to environmental noise.

Further, the error-mitigation approach in accordance with this disclosure can be applicable to multiple types of quantum information processing (QIP) systems and qubit technologies, and is compatible with existing noise cancellation strategies. While various aspects of the noise cancellation approach are described with reference to a QIP system based on trapped-atom qubits, the disclosure is not limited in that respect. Indeed, the noise cancellation approach in accordance with this disclosure can be used in other types of QIP systems based on solid-state qubits. Additionally, while described with reference to qubits, the noise cancellation approach of this disclosure can in some cases be implemented for other types of quantum devices, such as qudit devices.

It is to be appreciated that aspects of the present disclosure improve the functioning of a computing system such as a QC by reducing noise in the computer elements of the QC including in some circumstances the stored information elements (qubits) themselves. In this way, optimum performance may be achieved by a QC due to a stable, noise-free local environment.

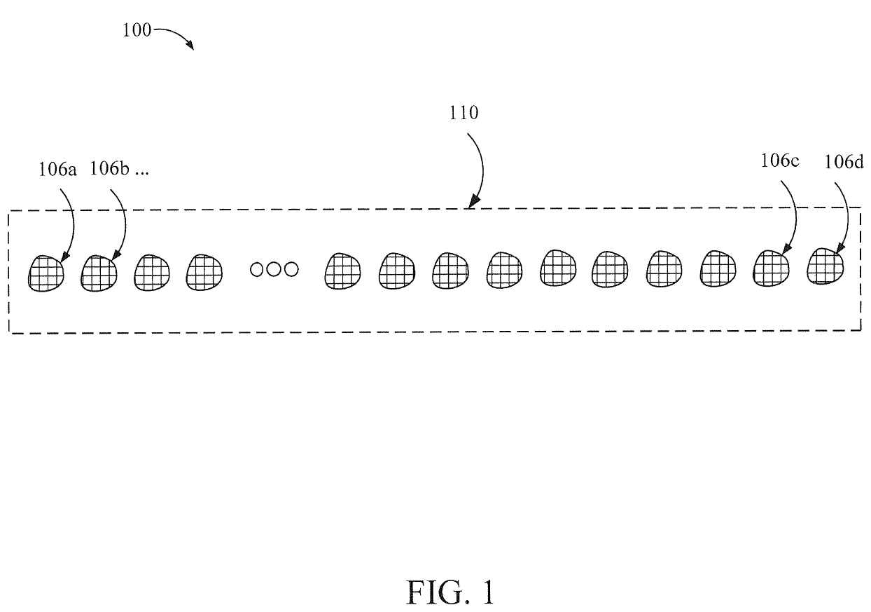

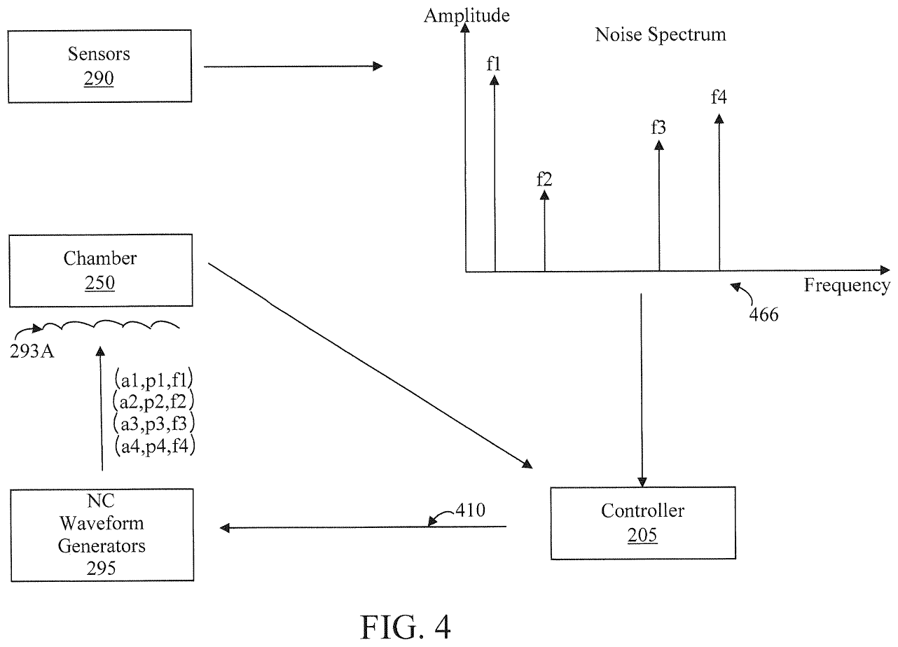

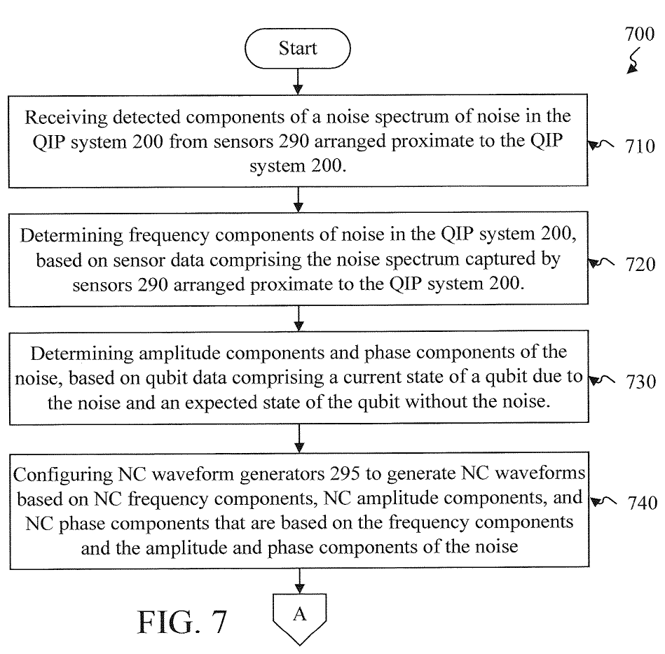

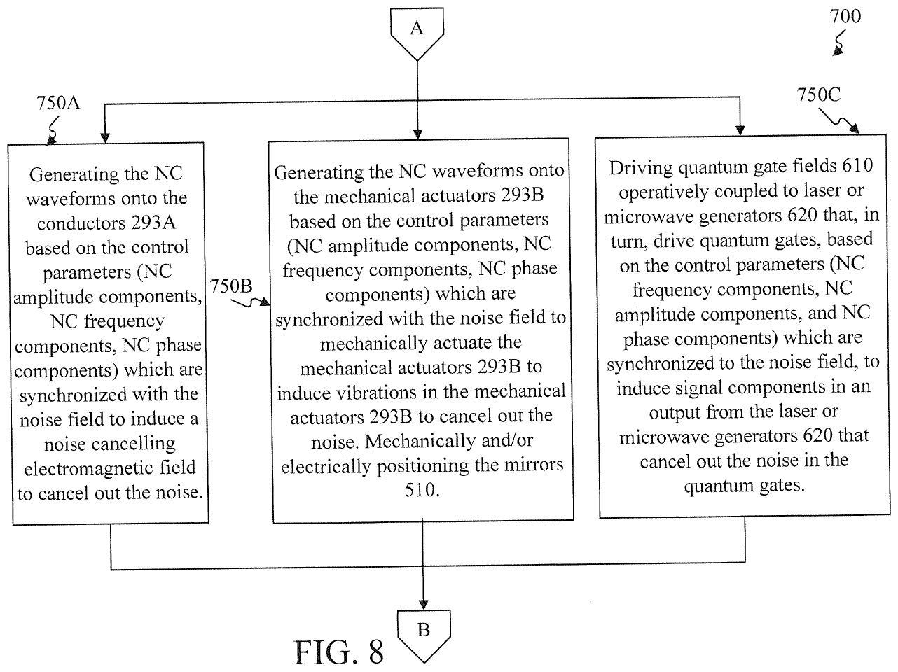

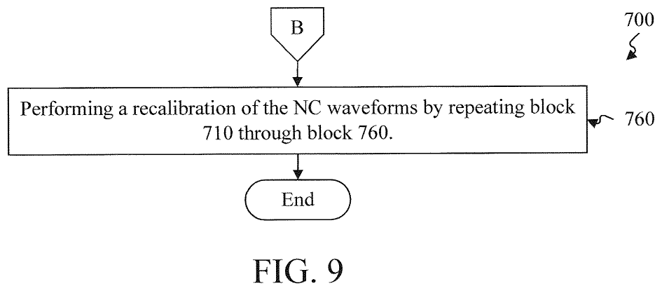

Solutions to the issues described above are explained in more detail in connection with FIGS. 1-9, with FIGS. 1-3 providing a description of QIP systems or quantum computers, and more specifically, of atomic-based QIP systems or quantum computers, with FIGS. 4-6 providing a description of a noise cancellation system in cooperation with various elements of a QIP system, and FIGS. 7-9 describe a method for noise cancellation in a QIP system.

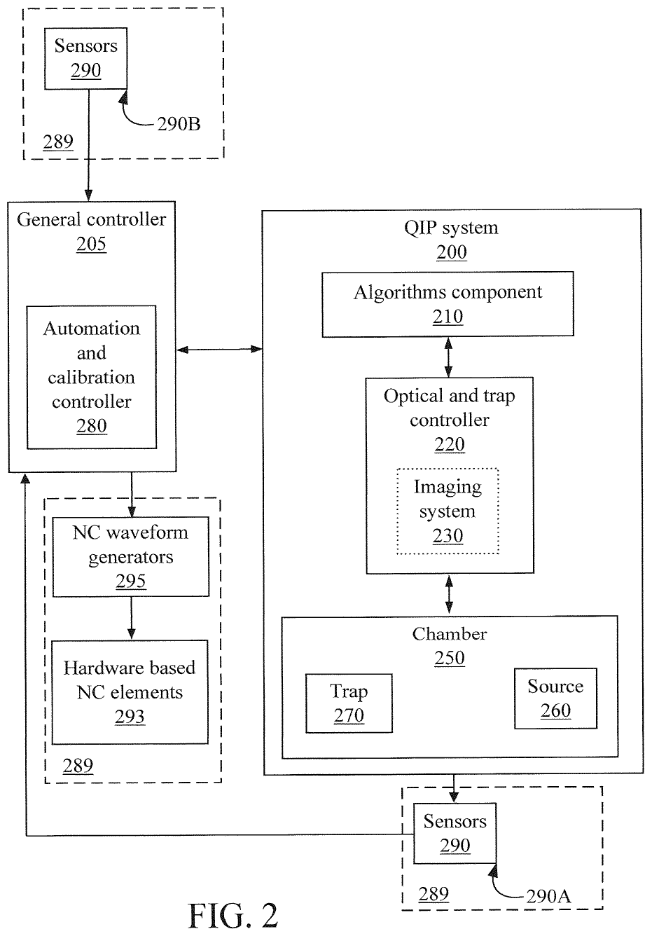

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., ^{171Yb+} ions), for example. The atomic ions are illuminated with laser (optical) radiation tuned to a resonance in ^{171Yb+} and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

In an aspect, general controller 205 is configured to implement noise cancellation functions of the noise cancellation system 289 as described herein. In an aspect, the general controller 205 represents the controller of the noise cancellation system. In another aspect, a separate controller can be used to control the other components of the noise cancellation system.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

The QIP system 200 may include, or may interface with, at least some components of a noise cancellation system 289. In an aspect, the noise cancellation system 289 includes sensors 290, noise cancelling (NC) waveform generators 295, and one or more hardware based NC elements 293 (hereafter mentioned in plural form as “hardware based NC elements”). According to the aspect of FIG. 2, some elements of the noise cancellation system 289 are shown external to the QIP system 200 but in cooperative communication with the QIP system 200. In another aspect, the noise cancellation system 289 may be fully included in the QIP system 200 or fully separate from the QIP system 200. In the aspect of FIG. 2, the general controller 205 and the imaging system 230 of the optical and trap controller 220 as well as the algorithms component 210 may be used by the noise cancellation system 289 to cooperatively cancel the noise.

In an aspect, the sensors 290 may detect sensor data (e.g., frequency components and amplitude components) representative of a noise spectrum of mechanical and/or environmental noise in the QIP system 200. In an aspect, at least some of the information may be provided to the general controller 205 to enable the general controller 205 to adjust parameters such as frequency components of the output of the NC waveform generators 295. In an aspect, qubit data relating to qubit states due to noise and without noise may be provided to the general controller 205 to enable the general controller 205 to adjust parameters such as amplitude components and phase components of the output of the NC waveform generators 295. The frequency, amplitude, and phase of the NC waveforms generated by the NC waveform generators 295 are hereinafter interchangeably referred to as “NC amplitude components”, “NC phase components”, and “NC frequency components”, respectively. In an aspect, the NC waveform generators 295 may generate the NC waveforms of any shape including square waveforms and sinusoidal waveforms, given Fourier Transform theory and the understanding the any periodic waveform (including a square waveform) can be represented by a set of sinusoidal waveforms. The function of the NC waveform generators 295 is to generate NC waveforms which oppose the waveform of the noise. The NC waveforms are provided to the hardware based NC elements 293 to cancel out the noise.

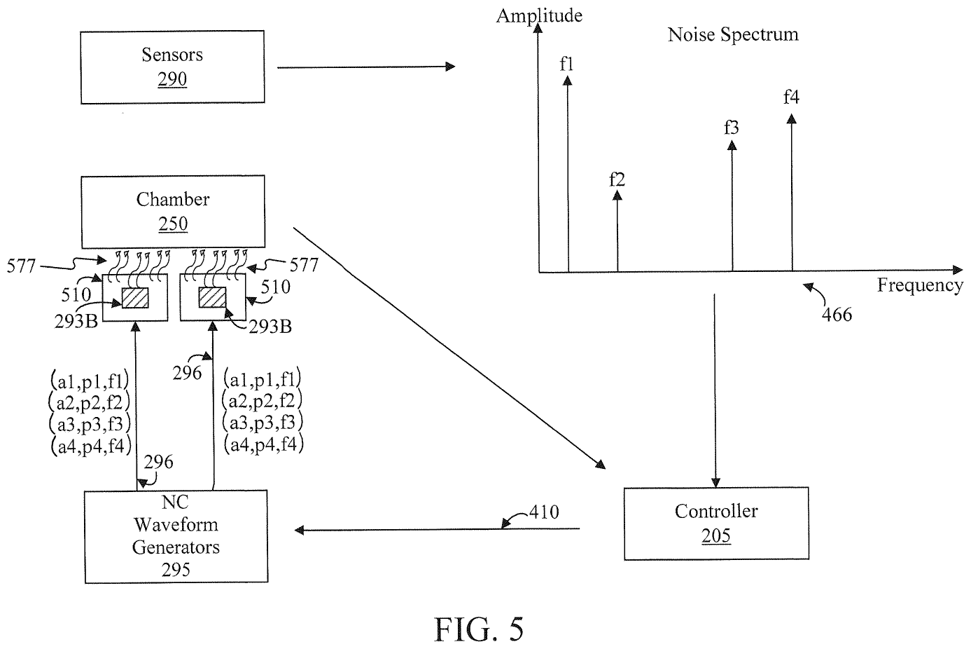

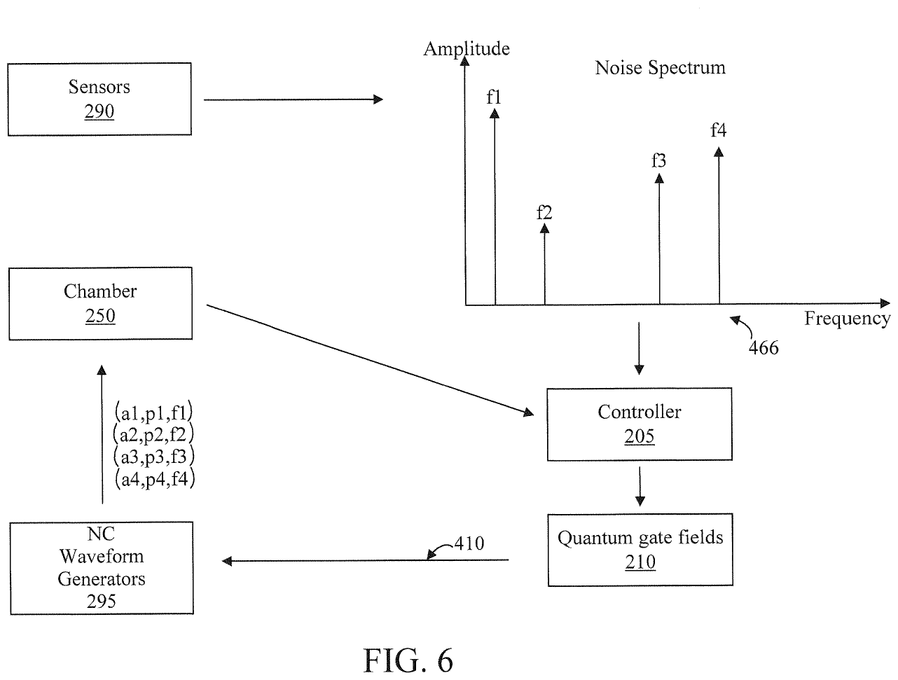

In an aspect, the hardware based NC elements 293 include conductors 293A such as one or more segments of wire (see, e.g., FIG. 4). For example, in an aspect, wire coils can be used as the hardware based NC elements 293 in order to counter magnetic field noise in the QIP system 200. In an aspect, the hardware based NC elements 293 include a set of mechanical actuators 293B (e.g., piezoelectric components) for inducting a resonance effect in the mechanical actuators (see, e.g., FIG. 5) to produce vibrations to counter mechanical noise in the QIP system 200. In an embodiment, the mechanical actuators 293B are arranged on mirrors 510 in order to provide directional vibrations to counter the mechanical noise in the QIP system 200. In an aspect, the hardware based NC elements 293 can be omitted. For example, in an aspect, quantum gate fields 610 used to drive laser or microwave generators 620 may be involved to reduce noise present in the quantum gate fields and/or laser or microwave generators 620 and/or quantum gates driven by the quantum gate fields 610 (see, e.g., FIG. 6). The quantum gate fields 610 and the laser or microwave generators 620 may be at least partially located in the optical and trap controller 220 and/or in the chamber 250.

In an aspect, the sensors 290 may include fluxgate magnetometers, gauss meters, SQUID magnetometers for magnetic field noise; accelerometers, capacitive displacement sensors, optical interferometers for vibrational noise; multimeters, oscilloscopes, ADC's for electric field noise measurements. Filters can be used to separate various frequency components, and dedicated electronic devices such as oscilloscopes can be used for generating TTL signals for synchronization to these isolated noise frequencies on QIP. In an aspect, the general controller 205 may be operatively coupled to or include a memory (not shown) to receive expected ambient levels of a controlled room. In another aspect, the sensors 290 may include proximate sensors 290A and not as proximate sensors 290B with respect to a position relative to QIP system 200 or components of QIP system 200 (such as the chamber 250 or trap 270). Both sensors 290A and sensors 290B are considered proximate to the CIP system 200, just to different degrees. One of skill in the art can appreciate that electromagnetic field strength and thus corresponding noise levels in a QIP system are typically low level and drop off significantly at distance, and so proximate location of the sensors 290 is needed, and is intended to mean within a distance capable of determining components of the noise field that is intended to be cancelled out. This also applies to being near a source of vibration in order to detect source components and not harmonics of the vibration based on reflection off of other intermediate surfaces (multipath) and other undesired affects that can be introduced when the sensors are placed too far. Information from sensors 290A and 290B can be manipulated (subtracted, added, etc.) in a way to determine the noise that is superimposed on the ambient sound level as known by one of skill in the art.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210.

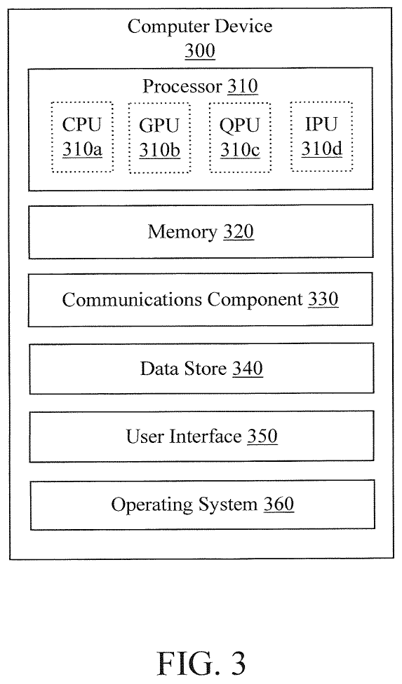

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In operation of the QIP system, qubit frequency may shift due to noise, resulting in control phase mismatch between quantum gates and qubits and result in errors. Aspects of the present disclosure measure the noise outside and check for periodic noise, e.g., 60 HZ noise from the electronics or a few Hertz noise from the cryostats, and apply waveforms having the same frequency components and adjust the amplitude components and/or phase components to cancel out the noise. The underlying assumption is that noise is stable under long time scales. Thus, the noise cancelling (NC) waveforms in accordance with the present disclosure can be applied. Over time, due to shifting of the noise, as determined by the sensors 290, the NC waveforms may need to be recalibrated, as mentioned below in a recalibration step of method 500.

One or more aspects of the present disclosure perform a Ramsey experiment. A T₂* Ramsey experiment measures the dephasing time, T₂*, of a qubit and the qubit's detuning, which is a measure of the difference between the qubit's resonant frequency and the frequency of the rotation pulses being used to perform the T₂* Ramsey experiment. Applied cancellation field amplitude and phase can be optimized by measuring the dephasing time and attempting to increase it as qubit frequency fluctuations are reduced when the noise is cancelled.

FIGS. 4-9 below describe various features of the present disclosure, in accordance with various aspects. While the present disclosure is not limited to the specific QIP system shown in FIG. 2 and may be applied to other systems configurations and types as mentioned herein, QIP system 200 will be used hereinafter in describing the various features of the present disclosure, including with respect to FIGS. 4-9.

Referring to FIGS. 2 and 4-6, the noise cancellation system 289 uses sensors 290 in conjunction with qubits to directly probe the noise (and capture a noise spectrum 466 and noise spectrum 566) and apply an opposing field to cancel out the noise. In an aspect, the sensors 290 are only used for triggering the NC waveform generators 295 to synchronize the noise and cancellation fields. That is, the sensors 290 provide the information on frequency and timing components for the noise cancellation waveform, while the qubits may be used to tune in the amplitude and phase components.

Referring now to FIGS. 2 and 4, various components of noise cancellation system 289 in conjunction with cooperative elements of QIP system 200 are shown and described in accordance with an exemplary aspect. Noise cancellation system 289 and QIP system 200 are initially described with respect to FIG. 2. In the aspect of FIG. 4, the hardware based NC elements 293 are conductors 293A such as wires (e.g., coiled wires), but can also be metal layers or lines in one or more semiconductor devices or some other type of conductor.

Wires 410 or other conductive elements may be used to pass signals from the general controller 205 (as described above with respect to FIG. 2) to control the NC waveform generators 295. The NC waveform generators 295 output NC waveforms onto hardware based NC elements 293. The NC waveforms have the same amplitude and frequency as the noise, but have an opposing phase to the noise in order to cancel out the noise. The hardware based NC elements 293 may be conductors 293A such as wires formed into coils and arranged proximate to the chamber 250 or trap 270 of the QIP system 200 in order to cancel out noise found proximate to the chamber 250 or trap 270 by the sensors 290 (e.g., sensors 290A from among sensors 290A and sensors 290B).

Referring now to FIG. 2 and FIG. 5, various components of noise cancellation system 289 in conjunction with cooperative elements of QIP system 200 are shown and described in accordance with an exemplary aspect. Noise cancellation system 289 and QIP system 200 are initially described with respect to FIG. 2. In the aspect of FIG. 5, the hardware based NC elements 293 include mechanical actuators 293B (e.g., piezoelectric components). In an aspect, the mechanical actuators 293B may be placed on mirrors 510.

The mechanical actuators 293B are configured to exhibit a resonance effect responsive to the NC waveforms. That is, the mechanical actuators (e.g., piezoelectric components) 293B receive NC waveforms from the NC waveform generators 295 to induce a resonance effect in the mechanical actuators 293B causing the mechanical actuators 293B to vibrate with certain amplitude components, frequency components, and phase components that are also in accordance with the NC waveforms. In an exemplary aspect, the mirrors 510 are configured to direct the vibrations 577 of the mechanical actuators 293B towards specific components of QIP system 200 suspected of being a source of the noise in order to counteract unintended vibration (that is, mechanical noise) detected within QIP system 200, such as at electrodes (not specifically shown), cryostats (not specifically shown), and so forth as non-limiting component of QIP system 200 expected to see unintended vibration. In an aspect, the positioning of the mirrors may be electrically and/or mechanically controlled. Hence, the mechanical actuators 293B are controlled, by the NC waveform generators 295, to be subjected to noise cancelling (NC) waveforms having calculated NC amplitude components, NC frequency components, and NC phase components in order to induce vibrations in the mechanical actuators 293B related to the calculated NC amplitude components, NC frequency components, and NC phase components. In this way, counteracting vibrations 577 can be induced in the mechanical actuators 293B proximate to a vibration source or element subjected to unintended vibration. The controlling of the mechanical actuators 293B to vibrate can be considered to cause an intended vibration in the QIP system 200, but this intended vibration is specifically directed to counteracting (cancelling out) detected unintended vibration in QIP system 200.

In an aspect, the mirrors 510 may be electrically and/or mechanically or otherwise controlled to be positioned to direct the vibrations of the mechanical actuators 293B at a particular component or region of the QIP system 200. For example, the mirrors may be mounting on a rotating surface capable of being rotated to direct a focus of the mirror towards a particular direction(s). In an aspect, the general controller 205 can be configured to control (e.g., mechanically and/or electronically and/or electromechanically) the position of the mirrors.

Regarding the mechanical actuators 293B including piezoelectric components, the following materials may be included in the mechanical actuators 293B: crystalline; ceramic; or polymeric. Example piezoelectric ceramics include lead zirconate titanate (PZT), barium titanate, and lead titanate. Gallium nitride and zinc oxide may also be regarded as a ceramic due to their relatively wide band gaps. Semiconducting piezoelectric materials (PMs) offer features such as compatibility with integrated circuits and semiconductor devices. Inorganic ceramic PMs offer advantages over single crystals, including ease of fabrication into a variety of shapes and sizes not constrained crystallographic directions. Moreover, piezoelectric polymeric actuators, due to their processing flexibility, can be readily manufactured into specific shapes and sizes. It is to be appreciated that aspects of the present disclosure are not limited to the use or inclusion of piezoelectric materials in the mechanical actuators 293B.

Referring now to FIG. 2 and FIG. 6, various components of noise cancellation system 289 in conjunction with cooperative elements of QIP system 200 are shown and described in accordance with an exemplary aspect. Noise cancellation system 289 and QIP system 200 are initially described with respect to FIG. 2. In the aspect of FIG. 6, the hardware based NC elements 293 are omitted, and quantum gate fields 610 and quantum gates implemented by laser or microwave generators 620, which may be at least partially located in the optical and trap controller 220 and/or in the chamber 250, may be involved to reduce noise present in the quantum gate fields 610 and/or the quantum gates driven by the quantum gate fields 610.

In an aspect, the general controller 205 controls quantum gate fields 610 that drive laser or microwave generators 620 that, in turn, drive quantum gates, to output a signal that is synchronized to the noise field along the signal chain from the input to the quantum gate fields 610 (through conductors 410, e.g., wire or semiconductor material) to the output of the laser or microwave generators 620 to induce signal components in the output of the laser or microwave generators 620 that cancel out the noise in the quantum gates. The signal is synchronized to the noise in being based on at least one of the NC frequency, NC amplitude, and NC phase, and this (ese) characteristics carries through up to the laser or microwave energy exciting a quantum gate (qubit(s)) to account for qubit evolution noise (state due to noise versus state without noise).

Referring now to FIG. 2 and FIG. 4 (hardware based NC elements 293 are conductors 293A), FIG. 5 (hardware based NC elements are mechanical actuators 293B), and FIG. 6 (hardware based NC elements 293 are omitted; quantum gate fields and laser or microwave generators of the chamber 250 and/or optical and trap controller 220 are used to reduce noise present in the quantum gate fields and/or quantum gates driven by the quantum gate fields.) as described above and FIGS. 7-9, a noise cancellation method 700 for a QIP system is shown and described in accordance with an exemplary aspect. In an aspect, the noise cancellation method 700 can be at least primarily performed by the general controller 205. In an aspect, blocks 710 through 750A-C of method 700 may be performed by general controller 205, and block 760 of method 700 may be performed by NC waveform generators 295.

At block 710, the method 700 includes receiving detected components of a noise spectrum of noise in the QIP system 200 from sensors 290 arranged proximate to the QIP system 200.

In an aspect, the elements of the QIP system 200 to which the sensors 290 are arranged proximate to may include the chamber 250 or trap 270. In an aspect, the components detected by the sensors 290 may include frequency components. In an aspect, the components detected by the sensors 290 may further include amplitude components. However, the detected amplitude components may or may not be used to determine amplitude, instead relying upon the qubit to determine amplitude as described below.

At block 720, the method 700 includes determining frequency components of noise in the QIP system 200, based on sensor data comprising the noise spectrum captured by sensors 290 arranged proximate to the QIP system 200.

At block 730, the method 700 includes determining amplitude components and phase components of the noise, based on qubit data comprising a current state of a qubit due to the noise and an expected state of the qubit without the noise. States of the qubit, due to and without noise, include data relating electron spin, polarization, hyperfine or fine structure state and so forth. This data is used to calculate the amplitude and phase of the NC waveforms to be applied to cancel the noise.

In an aspect, the current state of the qubit due to noise, and optionally the expected state of the qubit without noise, may be determined, for example, by images taken by the imaging system 230 of the optical and trap controller 220. In an aspect, the imaging system 230 may take images corresponding the state of the qubit due to noise and optionally the expected state of the qubit without noise, and provide these images to the general controller 205 to determine the difference therebetween in terms of, or from which, the amplitude and phase of the noise imposed on the qubit can be determined. In an aspect, the qubit state due to noise, the qubit state without noise, and the difference therebetween are individually and collectively referred to herein as “qubit data” and thus may be used to refer to one or more of the preceding items. It is to be appreciated that unlike the prior art, qubit data is used to synchronize the NC waveforms to the difference in qubit values due to the inclusion of noise so that the compensation field is synchronized with the noise field.

In an aspect, the expected state of the qubit without noise can be represented by ideal images which may be computer generated and/or may represent qubit data taken under ideal (non-noise) conditions and/or may be received from a repository (not shown) of ideal (non-noise) qubit values given certain inputs.

In an aspect, the general controller 205 may receive and/or include and/or calculate itself data on expected states of the qubits without noise. In an aspect, the images are not needed to the expected states of the qubits without noise, as the data has already been derived from the images and is in data form to quicken the occurrence of the NC result as opposed to having to obtain the data from images of the qubit without noise. In an aspect, a theoretical result can be used for the values for the qubit without noise. These values can be prestored and provided as needed from the QIP system 200, the noise cancellation system 289, or a remote repository (not shown).

In an aspect, the general controller 205 may evaluate these images together with cooperation from the optical and trap controller 220 and the algorithms component 210. For example, the use of fluorescence to detect, identify, and label atomic ions using image processing algorithms may need to be coordinated with the optical and trap controller 220 and the algorithms component 210. These images and/or qubit data may be evaluated by the general controller 205 to determine the difference between the conditions of the qubit (due to noise and without noise).

At block 740, the method 700 includes configuring NC waveform generators 295 to generate NC waveforms based on NC frequency components, NC amplitude components, and NC phase components that are based on the frequency components and the amplitude and phase components of the noise. In an aspect, block 750 includes sending a control signal to the NC waveform generators 295 to control parameters (NC amplitude components, NC frequency components, NC phase components) of the NC waveforms generated by the NC waveform generators 295.

At block 750A, the method 700 includes generating the NC waveforms onto the conductors 293A based on the control parameters (NC amplitude components, NC frequency components, NC phase components) which are synchronized with the noise field to cancel out the noise. In this way, an electromagnetic field in opposition to the noise field is created by the conductors 293A that cancels out the noise in the QIP system 200. In an aspect, the conductors 293A are coiled wires that, when energized by the NC waveforms, cause an opposing electromagnetic field with respect to the electromagnetic field of the noise.

At block 750B, the method 700 includes generating the NC waveforms onto the mechanical actuators 293B based on the control parameters (NC amplitude components, NC frequency components, NC phase components) which are synchronized with the noise field to mechanically actuate the mechanical actuators 293B to induce vibrations in the mechanical actuators 293B to cancel out the noise. In an aspect, block 760 includes mechanically and/or electrically positioning the mirrors 510.

At block 750C, the method include driving quantum gate fields 610 operatively coupled to laser or microwave generators 620 that, in turn, drive quantum gates, based on the control parameters (NC frequency components, NC amplitude components, and NC phase components) which are synchronized to the noise field, to induce signal components in an output from the laser or microwave generators 620 that cancel out the noise in the quantum gates.

Block 750C differs from blocks 750A and 750B in determining at least one of: the NC frequency components; the NC amplitude components; the NC phase components. This is because the block 750 and block 750B are deriving signals from “scratch” and are not changing an existing signal to include NC components as is block 750C. Block 750C changes the signal that would otherwise be output from the quantum gate drives (the laser or microwave generators 620) and may only need to adjust one or two but not all three of the control parameters.

At block 760, the method 700 includes performing a recalibration of the NC waveforms by repeating block 710 through block 750 using dynamic sensor and dynamic qubit data feedback. That is, sensor data and qubit data is newly recaptured at predetermined or random times under the control of the general controller 205 in order to sense noise and react to the noise, i.e., cancel the noise. The general controller 205 and the imaging system 230 of the optical and trap controller 220 as well as the algorithms component 210 may be used by the noise cancellation system 289 to cooperatively capture new qubit data periodically or randomly and adjust the NC waveforms accordingly in a dynamic feedback based manner. In this way, variations in the essentially steady state of the noise can be dynamically accounted for by the noise cancelling system 289 using a feedback loop formed from the recapture of the sensor and qubit data.

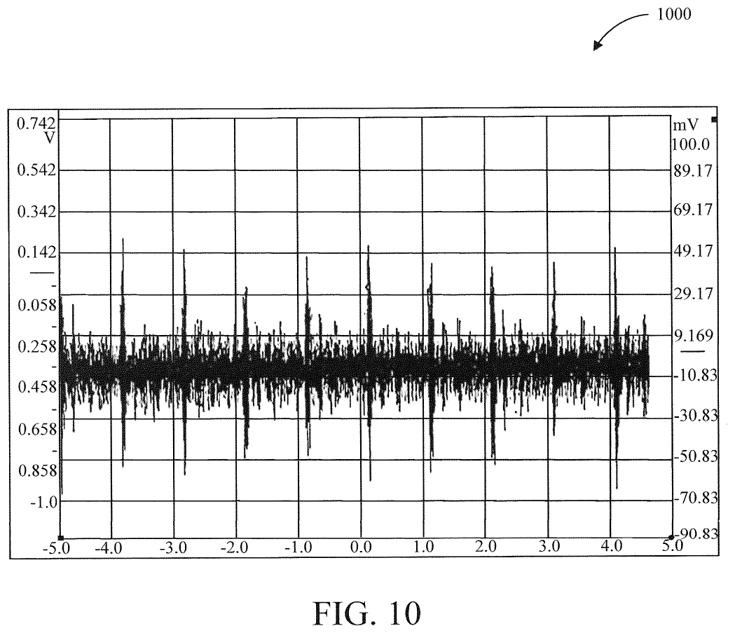

Referring to FIGS. 10-14, various plots 1100 through 1400 are shown relating to experiments and measurements in accordance with teachings of various aspects of the present disclosure.

Referring to FIG. 10, illustrates an example plot 1000 of amplitude versus time for a 1 Hz periodic noise signal in accordance with aspects of this disclosure.

Plot 1000 shows the 1 Hz periodic noise signal from an accelerometer placed close to a cryostat of as QIP system. Using the 1 Hz signal for synchronization, aspects of the present disclosure can involve applying a 1 Hz noise cancellation field on qubits, and adjusting the phase of the applied noise cancelling signal to find the optimal phase.

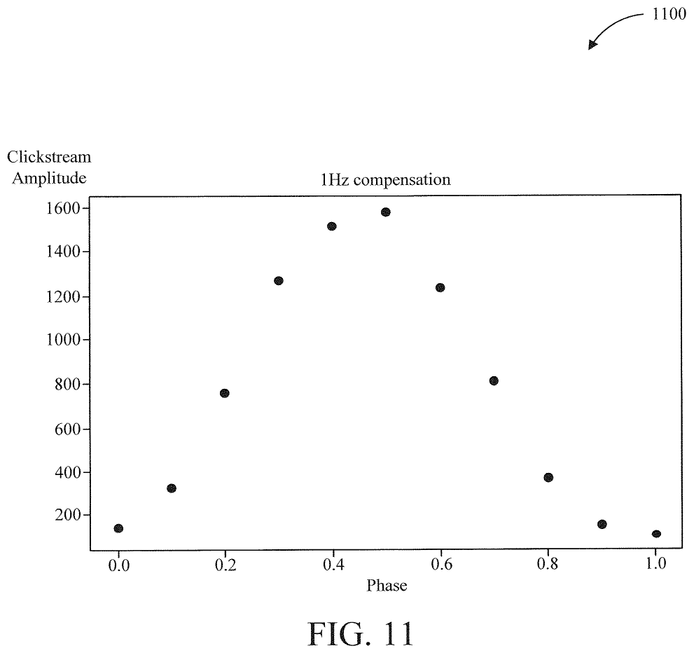

Referring to FIG. 11, an example plot 1100 of clickstream amplitude measured on qubits versus phase for the 1 HZ periodic noise signal of FIG. 10 is shown, in accordance with aspects of this disclosure.

The clickstream amplitude indicates a measure of noise on qubits, and the phase indicates the NC field phase*2π in radians. Hence, 0 and 1 correspond to the same applied signal. Noise is minimized around when the phase=0. After the phase component is extracted from the qubit data, similar measurement is done on the amplitude of noise cancellation.

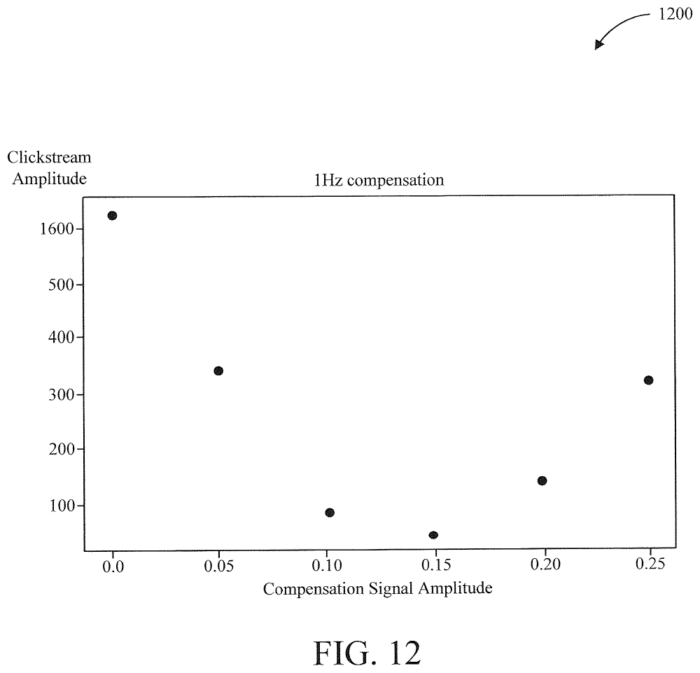

Referring to FIG. 12, an example plot 1200 of clickstream amplitude versus compensation signal amplitude is shown, in accordance with aspects of this disclosure. The clickstream amplitude indicates a measure of noise on qubits at 1 Hz frequency, and the compensation signal amplitude indicates the NC field amplitude in Volts. Noise is minimized at a compensation signal amplitude of 0.15 V. After this measurement, a NC signal with frequency of 1 Hz, phase of 0 and amplitude of 0.15 V is applied to a wire coil to cancel magnetic field noise on the qubits.

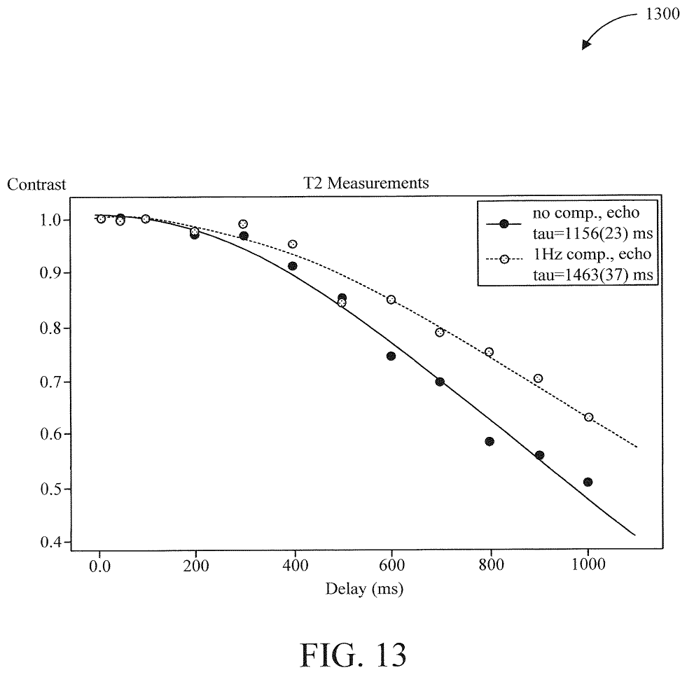

Referring to FIG. 13, an example plot 1300 of contrast versus delay corresponding to Ramsey experiments is shown, in accordance with aspects of this disclosure. To verify the noise reduction, a Ramsey experiment is performed with and without noise cancellation. In this experiment, ideal contrast on qubit state oscillation would be at 1 for all delay times. Decay in the contrast show T2* time of the qubits. Without noise cancellation, 1.2 seconds of coherence time are observed, whereas a coherence time of 1.5 seconds results from a 1 Hz cancellation signal. To increase the coherence time further, other noise frequency components could be identified and cancelled in a similar manner.

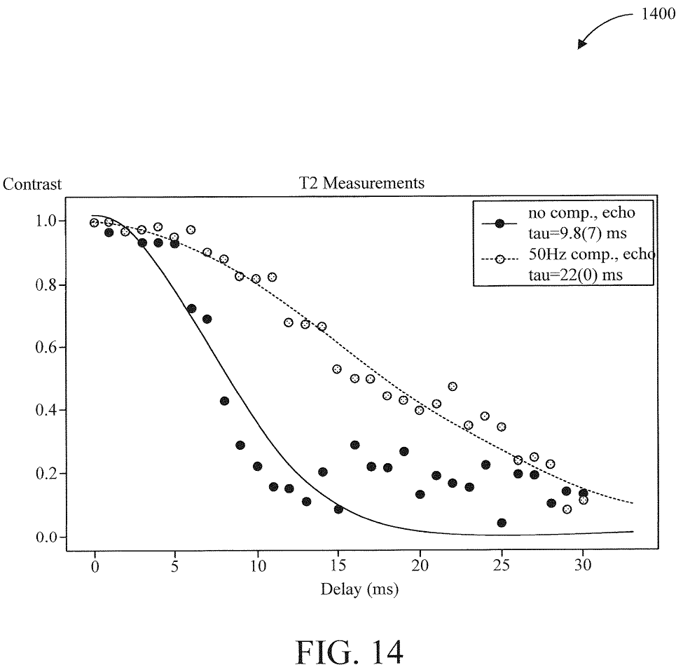

Referring to FIG. 14, illustrates another example plot 1400 of contrast versus delay corresponding to Ramsey experiments in accordance with aspects of this disclosure. Plot 1400 corresponds to conducting similar experiments as for resulting plot 1300, but on a qubit more sensitive to magnetic field noise. A factor of two improvement is observed on coherence time, increasing from 10 ms to 22 ms, when 50 Hz noise coming from the cryostat in the QIP system is cancelled using a magnetometer sensor for synchronization.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A computer-implemented method, comprising:
detecting sensor data comprising a noise spectrum by at least one sensor;
calculating frequency components of noise in a quantum information processing (QIP) system based on the sensor data;
determining amplitude components and phase components of the noise, based on qubit data comprising a current state of a qubit due to the noise and an expected state of the qubit without the noise;
configuring a noise cancelling (NC) waveform generator to generate NC waveforms in accordance with NC frequency components, NC amplitude components, and NC phase components that are based on the frequency components and the amplitude and phase components of the noise; and
applying, by the NC waveform generator, the NC waveforms to a hardware based NC element to cancel out the noise.

2. The computer-implemented method according to claim 1, wherein the hardware based NC element comprises one or more segments of wire located by elements of the QIP system.

3. The computer-implemented method according to claim 1, wherein the hardware based NC element comprises one or more mechanical actuators configured to exhibit a resonance effect responsive to the NC waveforms.

4. The computer-implemented method according to claim 3, further comprising electrically or mechanically controlling a positioning of mirrors coupled to mechanical actuators that direct vibrations from the mechanical actuators towards a source of the noise.

5. The computer-implemented method according to claim 3, wherein the mechanical actuators have piezoelectric components.

6. The computer-implemented method according to claim 1, wherein at least some of the sensors are located by a chamber of the QIP system and at least other ones of the sensors are located further from the chamber of the QIP system.

7. The computer-implemented method according to claim 1, further comprising determining at least one of the current state of the qubit due to noise and the expected state of the qubit without noise based at least on images captured by an imaging system of the QIP system.

8. The computer-implemented method according to claim 1, further comprising determining the expected state of the qubit without noise based on images received from a remote image repository.

9. The computer-implemented method according to claim 1, further comprising determining the expected state of the qubit without noise based on prestored values.

10. The computer-implemented method according to claim 1, further comprising determining the amplitude components and the phase components of the noise from differences in amplitude components and phase components between the current state of the qubit due to noise and the expected state of the qubit without noise.

11. The computer-implemented method according to claim 1, wherein the configuring comprises sending a control signal to the NC waveforms generator to control parameters comprising the NC frequency components, the NC amplitude components, and the NC phase components of the NC waveforms generated by the NC waveform generator.

12. A computing system, comprising:
a hardware based noise cancelling (NC) element;
a waveform generator operatively coupled to the hardware based NC element and configured to apply NC waveforms to the hardware based NC element to cancel out noise in the computing system;
at least one processor operatively coupled to the waveform generator; and
a controller configured to:
detect sensor data comprising a noise spectrum by at least one sensor;
calculate frequency components of noise in a quantum information processing (QIP) system based on the sensor data;
determine amplitude components and phase components of the noise, based on qubit data comprising a current state of a qubit due to the noise and an expected state of the qubit without the noise; and
configure a noise cancelling (NC) waveform generator to generate NC waveforms in accordance with NC frequency components, NC amplitude components, and NC phase components that are based on the frequency components and the amplitude and phase components of the noise.

13. The computing system according to claim 12, wherein the hardware based NC element comprises one or more segments of wire located by elements of the computing system.

14. The computing system according to claim 12, wherein the hardware based NC element comprises one or more mechanical actuators configured to exhibit a resonance effect responsive to the NC waveforms.

15. The computing system according to claim 14, wherein the mechanical actuators are arranged on mirrors to direct vibrations from the mechanical actuators towards a source of the noise, and a positioning of the mirrors is at least one of electrically and mechanically controlled.

16. The computing system according to claim 14, wherein the mechanical actuators have piezoelectric components.

17. A quantum information processing (QIP) system comprising:
a hardware based noise cancelling (NC) element;
a waveform generator operatively coupled to the hardware based NC element and configured to apply NC waveforms to the hardware based NC element to cancel out noise in the QIP system;
at least one processor operatively coupled to the waveform generator; and
a controller configured to:
detect sensor data comprising a noise spectrum by at least one sensor;
calculate frequency components of noise in a quantum information processing (QIP) system based on the sensor data;
determine amplitude components and phase components of the noise, based on qubit data comprising a current state of a qubit due to the noise and an expected state of the qubit without the noise; and
configure a noise cancelling (NC) waveform generator to generate NC waveforms in accordance with NC frequency components, NC amplitude components, and NC phase components that are based on the frequency components and the amplitude and phase components of the noise.

18. The QIP system according to claim 17, wherein the hardware based NC element comprises one or more segments of wire located by elements of the QIP system.

19. The QIP system according to claim 17, wherein the hardware based NC element comprises one or more mechanical actuators configured to exhibit a resonance effect responsive to the NC waveforms.

20. A computer-implemented method, comprising:
determining at least one of:
(i) frequency components of noise in quantum gates of a quantum information processing (QIP) system, based on sensor data comprising a noise spectrum captured by sensors; and
(ii) amplitude components and (iii) phase components of the noise, based on qubit data comprising a current state of a qubit due to the noise and an expected state of the qubit without the noise;
configuring quantum gate drivers to generate noise cancelling (NC) signals in accordance with the at least one of NC frequency components, NC amplitude components, and NC phase components that are based on the frequency components and the amplitude and phase components of the noise; and
applying, by the quantum gate drivers, the NC signals to the quantum gates to cancel out the noise.
